(19) United States
(12) Patent Application Publication
(10) Pub. No.: US 2007/0101846 A1
(43) Pub. Date: May 10, 2007

(54) Compensating stripper rings for material slitting machines

(76) Inventor: Lloyd P. Zahn, New Brighton, PA (US)

Correspondence Address: KIRKPATRICK & LOCKHART PRESTON GATES ELLIS LLP, 535 SMITHFIELD STREET, PITTSBURGH, PA, 15222, US

(21) Appl. No.: 11/268,004

(22) Filed: Nov. 7, 2005

(51) Int. Cl. B27B 5/34; B23D 25/12

(52) U.S. Cl. 83/508.3; 83/343

(57) ABSTRACT

Stripper rings and knife holder assemblies for use with material slitting machines. Various disclosed stripper ring embodiments have annular grooves formed in the lateral faces of the ring to permit the ring to compress in separate directions when encountering compressive forces during operation.

### BACKGROUND OF THE INVENTION

1. Field of the Invention

The invention relates generally to slitter machines for slitting sheet materials into strips and, more particularly, to knife arrangements and stripper rings for use on such slitting machines.

2. Description of the Invention Background

Much of the steel produced by mills is in the form of coiled steel sheet, but rarely does the sheet correspond in width to the multitude of products that are stamped or otherwise formed from it. Accordingly, the steel sheet is usually slit longitudinally to sizes suitable for the particular products. Indeed, special slitting machines are made for this purpose.

The typical slitting machine has circular blades or knives arranged in pairs on two powered shafts or arbors, there being one knife of each pair on one of the arbors and the second knife of the pair on the other arbor. The arbors are connected to a drive system for counter-rotation. During operation, sheet metal is moved between the arbors and cut into strips or “mults” by the knives counter-rotating on the arbors. Actually, each knife may be nothing more than a hardened steel disk having flat end faces and a cylindrical peripheral face which intersects the end faces at relatively sharp cutting or shearing edges. The disks of each pair are positioned on their respective arbors, often with a slight overlap. Overlap or not, the knives of each pair are positioned close enough to each other to enable them to cut or shear the metal sheet as it passes between those knives. In other words, the metal sheet is drawn between the two knives of a pair the disk-like knives shear the sheet along the opposite cutting edges, thus producing a clean longitudinal cut in the sheet. Not only are the disk-like knives arranged in pairs, but the pairs of knives are also usually organized into left and right hand configurations to present similar slit burr orientation on the slit strands. That is, on one strip, the slit burrs will face upward and on adjacent strips the burrs will face downward, such that the burr orientation will alternate on the adjacent strips.

In many slitting arrangements, stripper rings are journaled on the arbors adjacent each side of the disk-like knife. In practice, the stripper rings are arranged in “male” and “female” pairs with the male stripper ring located on one drive shaft and a corresponding female stripper ring located on the other drive shaft adjacent the cutting edges of the knives. Such stripper rings serve to support the strip material through the cutting operation and provide space to compensate for the required “vertical” travel of the cutting knives. These male and female stripper rings are commonly fabricated from solid rubber or Urethane and, although may have a modicum of flexibility, they are generally not flexible enough to accommodate different thicknesses of metal or other material to be slit without the exchange of smaller or larger female stripper rings selected to compensate for various material thicknesses to be slit. This exchange requires retooling the slitter head for proper stripper ring pinch pressure and leads to undesirable machine downtime and associated labor costs.

Thus, as can be appreciated from the forgoing discussion, there is a need for a stripper roll that can accommodate different thicknesses of materials.

There is a further need for a knife assembly for use on a material slitting machine that can readily accommodate different material thicknesses.

There is yet another need for a slitting method that can accommodate different material thicknesses without having to physically adjust or alter the female stripper ring diameter.

### SUMMARY

In accordance with one embodiment of the present invention, there is provided a stripper ring for use on a material slitting machine. One embodiment of the stripper ring comprises a flexible ring that has a mounting hole extending therethrough. The flexible ring further has a circumferentially extending driving surface and a first lateral face that extends between the circumferentially extending driving surface and the mounting hole. A second lateral face extends from the circumferentially extending driving surface and the mounting hole. A first annular groove is provided in the first lateral face and a second annular a groove is provided in the second lateral face.

In accordance with another embodiment of the subject invention, there is provided a stripper ring for use on a material slitting machine. One embodiment of the stripper ring comprises a ring that has a central portion with a mounting hole extending therethrough. The central portion further has a first lateral face with first relief means therein and a second lateral face with second relief means therein and a circumferentially extending driving surface. The first and second relief means serve to enable a portion of the stripper ring to deflect in two different directions upon the application of compressive force to the portion of the stripper ring.

In accordance with yet another embodiment of the subject invention, there is provided a knife assembly for a slitting machine having a drive shaft. One embodiment of the knife assembly comprises a knife holder assembly that is attachable to the drive shaft for rotatable travel therewith. A rotary knife is supported by the knife holder assembly. The rotary knife has a shearing face, a circumferentially extending end surface and a mounting face wherein the shearing face and the circumferentially extending end surface form a shearing edge. A female stripper ring is supported by the knife holder assembly adjacent the shearing face of the rotary knife. The female stripper ring has a first circumferentially extending driving surface formed thereon and is constructed to permit at least a portion of the female stripper ring to compress in two different directions upon the application of compressive force to a corresponding portion of the first circumferentially extending driving surface. A male stripper ring is supported by the knife holder assembly adjacent the mounting face of the rotary knife.

In accordance with another embodiment of the subject invention there is provided a material slitting machine that comprises a driven upper shaft and a driven lower shaft that is supported in spaced relation to the driven upper shaft. At least one upper knife holder assembly is mounted to the driven upper shaft. One upper knife holder assembly embodiment includes an upper rotary knife that is supported by the upper knife holder assembly. The upper rotary knife has an upper shearing face, an upper mounting face and a circumferentially extending upper end surface, wherein the upper shearing face forms an upper shearing edge with the upper end surface. An upper female stripper ring is supported by the upper knife holder assembly adjacent the upper shearing face of the upper rotary knife. The upper female stripper ring has a circumferentially extending upper driving surface formed thereon and is constructed to permit at least a portion of the upper female stripper ring to comprises in two different directions upon an application of compressive force to a corresponding portion of said upper driving surface. An upper male stripper ring is supported by the upper knife holder assembly adjacent the upper mounting face of the upper rotary knife. The machine further comprises at least one lower knife holder assembly mounted to the driven lower shaft wherein at least one lower knife holder assembly corresponds to one of the upper knife holder assemblies. In one embodiment, the lower knife holder assembly comprises a lower rotary knife that is supported by the lower knife holder assembly. The lower rotary knife has a lower shearing face, a lower mounting face, and a circumferentially extending lower end wherein the lower shearing face forms a lower shearing edge with the lower end. The lower shearing edge is oriented adjacent to the upper shearing edge of the upper rotary knife corresponding thereto. The lower end of the lower rotary knife is oriented in confronting relationship with respect to the upper driving surface of the upper female stripper ring of the upper knife holder corresponding thereto. A lower female stripper ring is supported by the lower knife holder assembly adjacent to the lower shearing face of the lower rotary knife. The lower female stripper ring has a circumferentially extending lower driving surface formed thereon and is constructed to permit at least a portion of the lower female stripper ring to compress in two other different directions upon application of other compressive forces to a corresponding portion of the lower driving surface that is in confronting relationship with at least a portion of the upper male stripper ring and a portion of the upper rotary knife. A lower male stripper ring is supported by the lower knife holder assembly adjacent to the lower mounting face of the lower rotary knife and is oriented in confronting relationship relative to at least a portion of the upper drive surface of the upper female stripper ring.

Accordingly, various embodiments of the invention provide solutions to the shortcomings of other stripper rings and slitting machine arrangements. Those of ordinary skill in the art will readily appreciate, however, that these and other details, features and advantages will become further apparent as the following detailed description proceeds.

### BRIEF DESCRIPTION OF THE DRAWINGS

In the accompanying Figures, there are shown present embodiments of the invention wherein like reference numerals are employed to designate like parts and wherein:

FIG. 1 is a perspective view of a metal slitting machine which may employ various stripper ring embodiments of the present invention;

FIG. 2 is an end elevational view of the slitting machine of FIG. 1 with a plurality of stripper rings disclosed herein associated with corresponding knife holder assemblies operably mounted to the machine;

FIG. 3 is an end view of a lower portion of the slitter machine showing a knife holder assembly movably mounted thereto;

FIG. 4 is a side elevational view of the knife holder assembly depicted in FIG. 3;

FIG. 5 is a cross-sectional view of a portion of the upper and lower drive shaft assemblies with knife holder assemblies of the present invention mounted thereon;

FIG. 6 is a cross-sectional view of a corresponding pair of upper and lower knife holder assemblies mounted on the upper and lower drive shaft assemblies, respectively;

FIG. 7 is a front view of a stripper ring embodiment of the present invention;

FIG. 8 is an end view of the stripper ring of FIG. 7;

FIG. 9 is a cross-sectional view of a portion of the stripper ring of FIG. 8;

FIG. 10 is another cross-sectional view of a stripper ring embodiment of the present invention;

FIG. 11 is a partial cross-sectional view of upper and lower knife holder assemblies employing stripper rings of the present invention;

FIG. 12 is a cross-sectional view of a stripper ring mounted within a knife holder assembly illustrating the application of forces thereto; and

FIG. 13 is a cross-sectional view of a stripper ring mounted within a knife holder assembly with the cross hatching omitted for clarity and illustrating the application of forces thereto which cause the stripper ring to flex and which flexing is represented in phantom lines.

### DETAILED DESCRIPTION OF THE INVENTION

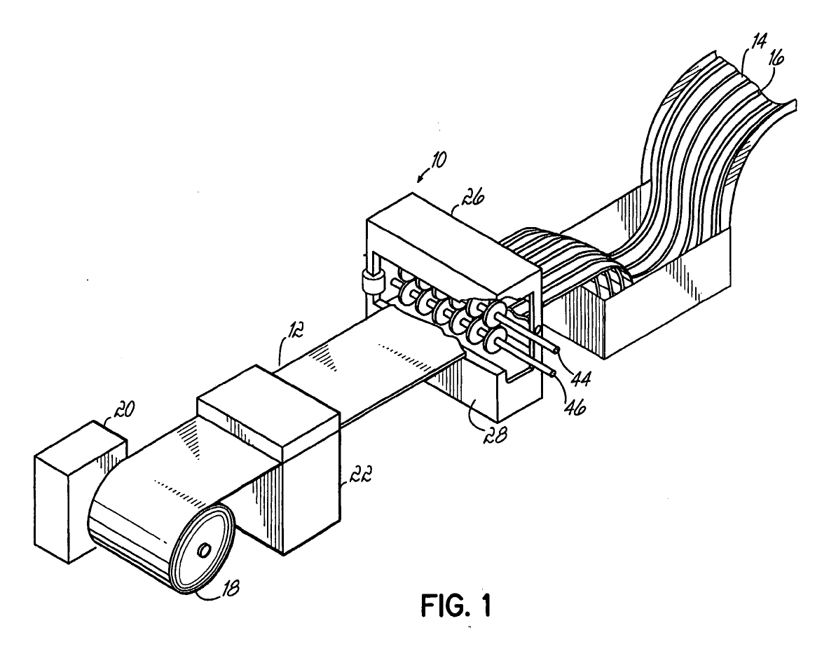

Referring now to the drawings for the purposes of illustrating the present embodiments of the invention only and not for the purposes of limiting the same, FIG. 1 illustrates one type of slitting machine 10 that may employ various embodiments of the stripper rings disclosed herein. Such slitting machine is disclosed in U.S. Patent Publication No. US 2003/0205117, entitled CNC SLITTER MACHINE, the disclosure of which is herein incorporated by reference in its entirety. Any patent, publication, or other disclosure material, in whole or in part, that is said to be incorporated by reference herein is incorporated herein only to the extent that the incorporated material does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

The slitting machine 10 is but one example of a slitting machine on which various embodiments of the stripper rings disclosed herein may be used. As illustrated in FIG. 1, the slitting machine 10 is used for shearing metal sheet 12, such as sheet steel, into multiple segments or mults 14 of a desired width along slits 16. Those of ordinary skill in the art will understand, however, that the unique and novel aspects of the stripper ring arrangements and knife holder assemblies disclosed herein may also be effectively employed in connection with slitter arrangement for slitting other types of materials without departing from the spirit and scope of the present invention. In the example depicted in FIG. 1, the metal sheet 12 is normally provided from a mill or other supplier of mill products in a coil 18. The coil 18 is supported on a spool 20. The metal sheet 12 is withdrawn from the coil 18 and fed into the machine 10. Typically, the metal sheet 12 passes through a straightening machine 22 to remove the coil set. The sheet 12 alternatively may be fed into the machine 10 in individual sections, preferably with the assistance of a skewed roller table (not shown) or the like.

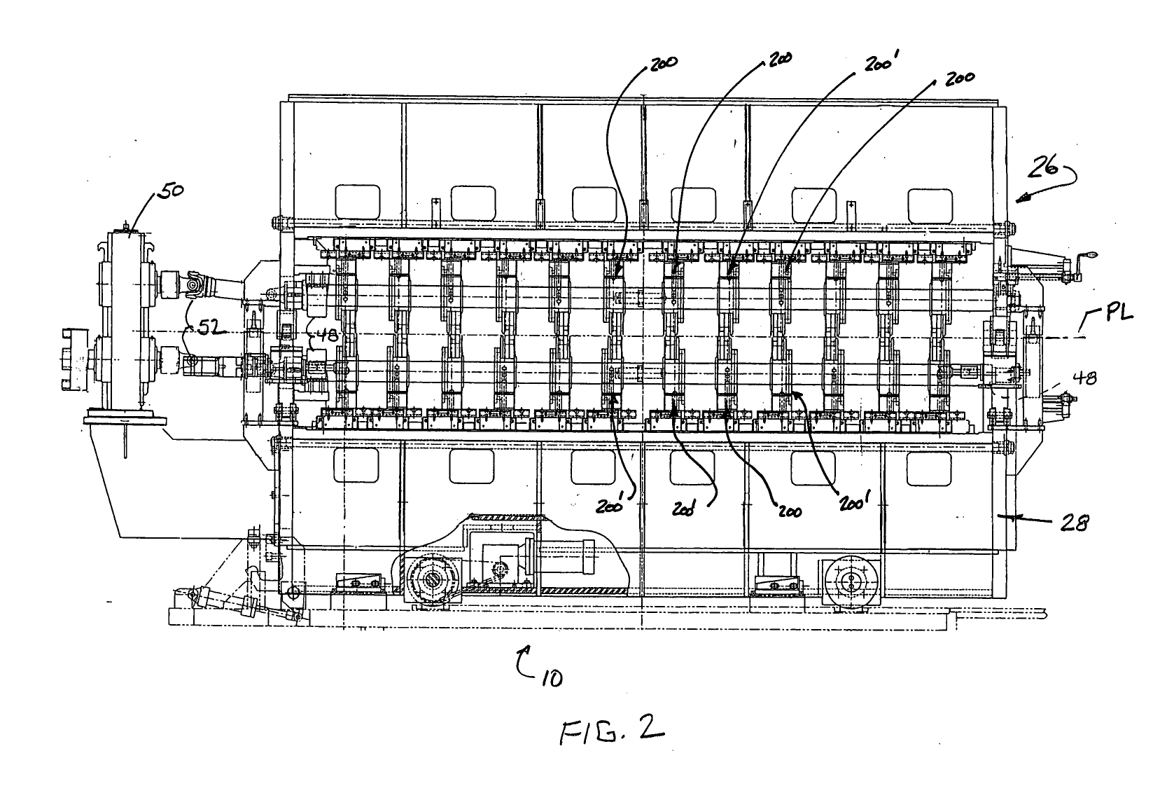

As can be further seen in FIGS. 1 and 2, the slitting machine 10 may include an upper frame 26 movably coupled at spaced ends thereof to a lower frame 28. The upper and lower frames 26, 28 of the machine 10 include upper and lower drive shaft assemblies 44, 46, respectively, mounted therein for rotation. The drive shaft assemblies 44, 46 are supported in the respective frames 26, 28 by spaced pillow block bearings 48. Corresponding ends of the upper and lower drive shaft assemblies 44, 46 are coupled to a gear box 50 by separate universal couplings 52. A motor 54 is connected to the gear box 50 to provide rotational movement through the gear box 50 to the universal couplings 52 and ultimately the drive shaft assemblies 44, 46. The drive shaft assemblies 44, 46 are rotated in opposite counter-rotating directions for pulling and slitting the metal sheet 12 passing therebetween.

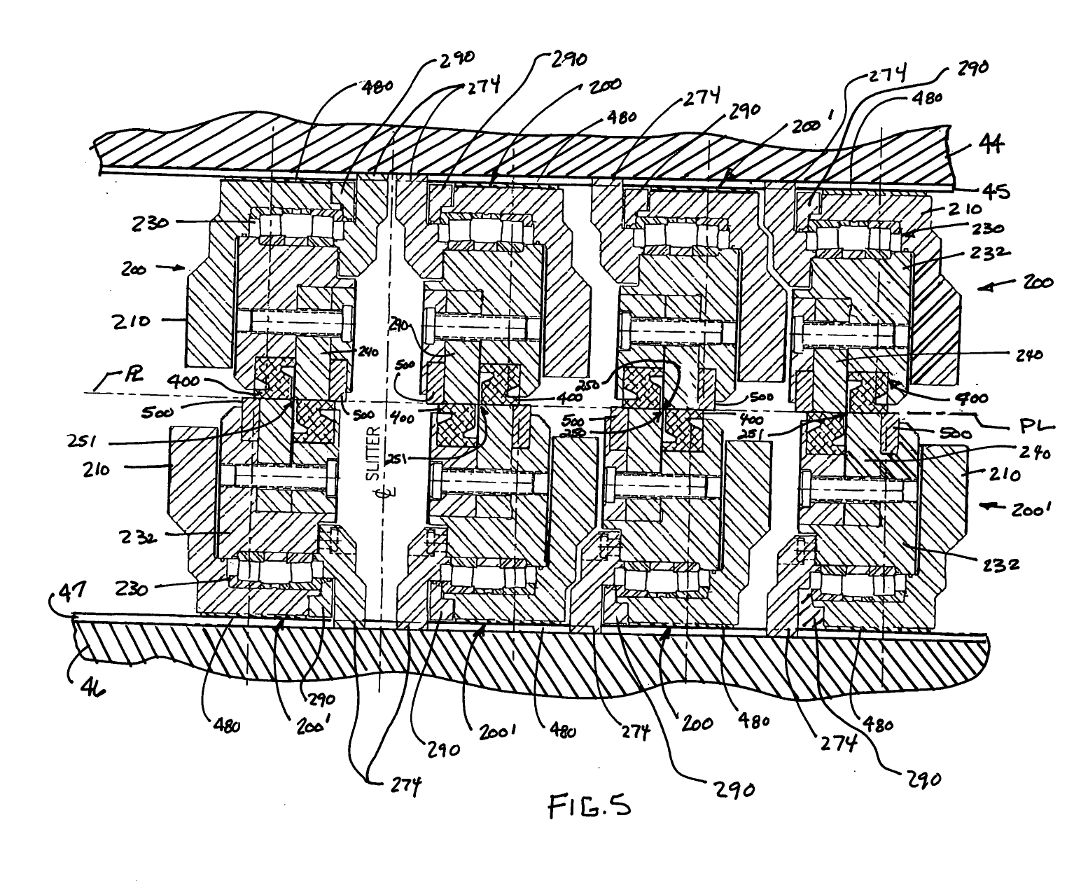

A number of knife holder assemblies 200, 200′ are supported for movement along the upper and lower drive shaft assemblies 44, 46, respectively, as shown in FIGS. 2 and 5. The knife holder assemblies 200, 200′ are supported in cooperating pairs at spaced positions along the upper and lower drive shaft assemblies 44, 46 in the upper and lower frames 26, 28, respectively. To provide the knife holders 200, 200′ with the ability to be positioned in close proximity to each other along their respective drive shafts, the knife holder assemblies 200, 200′ may be arranged as illustrated as shown in FIGS. 2 and 5 on each side of the slitter 10 centerline (CL). The knife holder assemblies 200, 200′ alternate across the slitter in “right hand” and “left hand” orientations. The right handed knife holder assemblies may be mirror images of the left handed knife holder assemblies and, therefore, the left handed knife holder assemblies 200, 200′ will only be described in detail herein.

The metal sheet 12 (or other material) to be slit passes between the knife holder assemblies 200, 200′ on the upper shaft 44 and the knife holder assemblies 200, 200′ on the lower shaft 46 along a pass line PL as indicated in FIG. 2. It will be appreciated that the exact number of knife holder assemblies 200, 200′ is generally dependent upon the desired width and configuration of the mults 14 and the metal sheet 12 or other material being slit. A holder assembly 200, 200′ may be supported on the upper and lower drive shaft assemblies 44, 46 in the manners described in the above-cited U.S. Patent Publication No. US2003/0205117 which has been herein incorporated by reference. In alternative embodiments, however, the knife holder assemblies 200, 200′ may be non-movably coupled to their respective drive shaft assemblies 44, 46. The reader will further appreciate that the drive shaft assemblies 44, 46 may also be configured in sections as described in U.S. Patent Publication No. US2003/0205117 or they may comprise single driven shaft arrangements.

In one non-limiting embodiment, the knife holder assemblies 200, 200′ are supported in cooperating pairs along the upper and lower drive shaft assemblies 44, 46 such that one knife holder assembly 200 of each pair is positioned along either the upper drive shaft assembly 44 or lower drive shaft assembly 46 and the complementary knife holder assembly 200′ of the pair is positioned along the upper drive shaft assembly 44 or lower drive shaft assembly 46 in complementary relationship thereto as illustrated in FIGS. 2, 5, and 6.

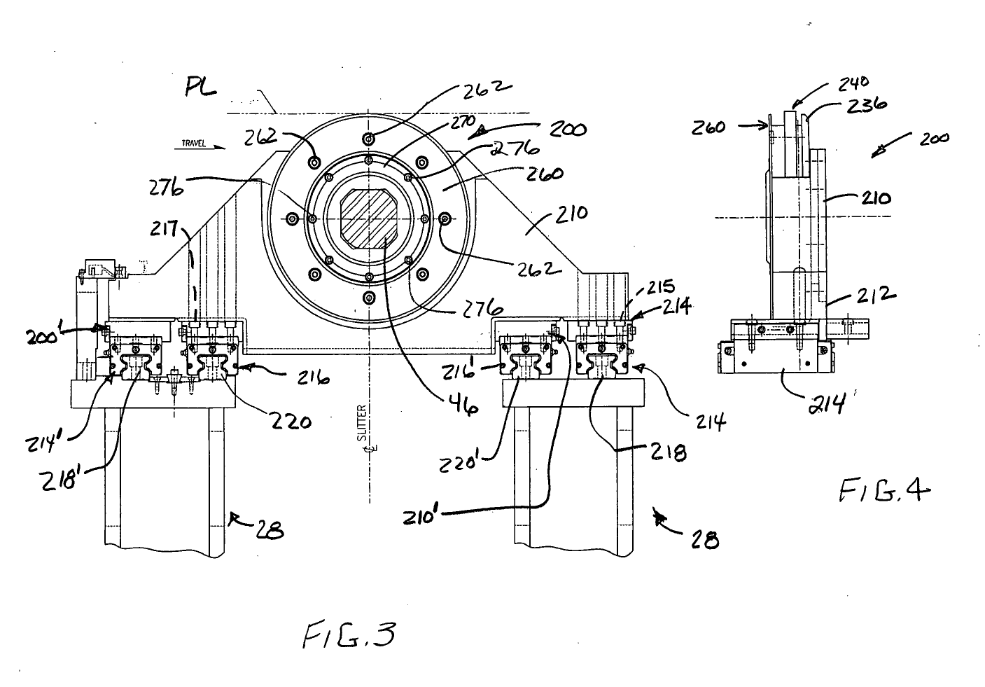

As shown in FIG. 3, the knife holder assemblies 200 (and 200′) are supported for linear movement along bearing rails. FIG. 3 illustrates one knife holder assembly 200 in front of an adjacent knife holder assembly 200′. The knife holder assembly 200 in that Figure includes a bearing arbor 210 that has an outer linear bearing block 214 attached thereto by, for example, cap screws 215 and an inner linear bearing block 216 attached thereto by cap screws 217. The outer linear bearing block 214 is mounted to a first outer rail 218 which is affixed to the lower frame 28 and extends laterally across the machine 10. Likewise, the inner linear bearing block 216 is movably received on a first inner rail 220 which is also affixed to the lower frame 28 and extends laterally across the machine 10. As can also be seen in FIG. 3, the adjacent knife holder assembly 200′ has a bearing arbor 210′ that has an outer linear bearing block 214′ and an inner linear bearing block 216′ attached thereto. The outer linear bearing block 214′ is movably mounted to a second outer rail 218′ which is affixed to the lower frame 28 and extends laterally across the machine 10. Likewise, the inner linear bearing block 216′ is movably received on a second inner rail 220′ which is also affixed to the lower frame 28 and extends laterally across the machine 10. By offsetting the bearing blocks from the center line of their respective knife holder assembly, better holder stability can be achieved. In addition, such arrangement enables adjacent holder assemblies to “nest” in the manner described in U.S. Patent Publication No. US 2003/020511. The reader will further appreciate that such linear bearing arrangements serve to enable the positions of the knife holder assemblies 200, 200′ to be selectively adjusted across the width of the machine.

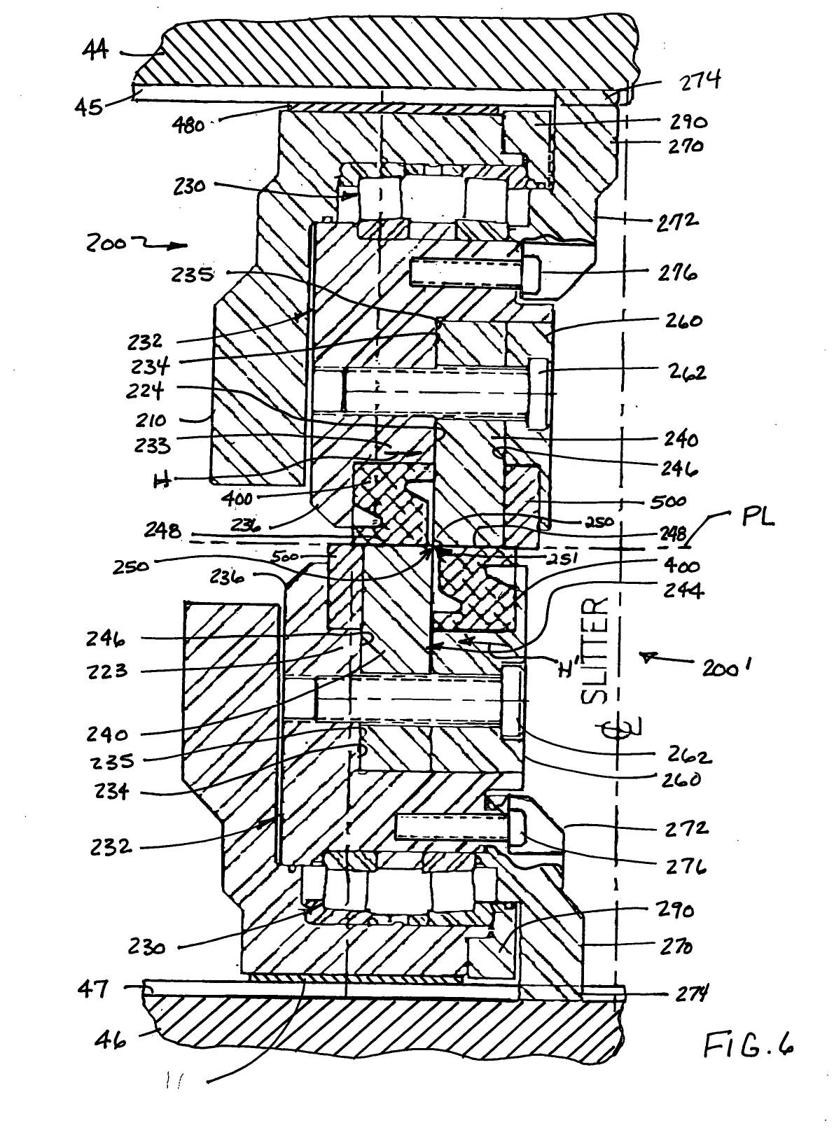

As can be most particularly seen in FIG. 6, a conventional bearing assembly 230 is mounted within the bearing arbor 210 to rotatably support a knife shaft 232 within the bearing arbor 210. The knife shaft 232 has a hub portion 233 that defines a first knife-receiving cavity 234 therein. In addition, a stripper ring retention flange 236 is also formed on one end of the knife shaft 232. A conventional disk-like knife 240 is mounted within the knife-receiving cavity 234. The disk-like knife 240 may be fabricated from tool steel and be formed with a shearing face 244, a mounting face 246 and a circumferentially extending end surface 248. The circumferentially extending end surface 248 forms a shearing edge or nip 250 with the shearing face 244. A portion of the knife 240 is supported within the knife-receiving cavity 234 such that the mounting face 246 abuts a lateral wall 235 of the knife-receiving cavity 234. A removable stripper ring retention flange 260 abuts a portion of the mounting face 246 and a series of cap screws 262 extend through the stripper ring retention flange 260 and knife 240 into the hub portion 233 of the knife shaft 232. It is conceivable that other fastener arrangements may be employed to affix the knife and stripper ring retention flange 260 to the knife shaft 232.

As can be seen in FIGS. 5 and 6, each knife holder assembly 200 further includes a female stripper ring 400 and a male stripper ring 500. The female stripper ring 400 is oriented between the shearing face 244 of the corresponding knife 240 and the flanged portion 236 of the knife shaft 232. The male stripper ring 500 is oriented between the mounting face 246 and stripper ring retention flange 260 that is mounted in the position shown in FIG. 6, by cap screws or other fasteners 262.

As can be seen in FIG. 6, the knife holder assemblies 200 also include drive flange 270 that is jounaled onto the respective upper drive shaft 44 or lower drive shaft 46, whichever the case may be. The drive flange 270 has a flanged portion 272 that may be affixed to the end of the hub portion 233 of the knife shaft 232 by a series of fasteners 276 or the like. See FIGS. 3 and 6. The drive flange 270 may further have a key 274 for receipt within a keyway 45 in the upper drive shaft 44 or a keyway 47 in the lower drive shaft 46, whichever the case may be. In alternative embodiments, the drive shafts 44, 46 may be square in cross-section or have another cross-sectional shape to enable the drive shafts to be received thereon without the need for keys and associated keyway arrangements. Regardless of which method is employed, such arrangement causes the drive flange 270, the knife shaft 232, knife 240 and female and male stripper rings 400, 500 to rotate with the drive shaft 44 or 46, whichever the case may be. The reader will further appreciate that the bearing assembly 230 enables the knife shaft 232, knife 240, and female and male stripper rings 400, 500 to rotate relative to the bearing arbor 210 as the drive shafts 44, 46 rotate. As can also be seen in FIGS. 5 and 6, in one embodiment, the knife holder assemblies may also include self lubricating bearings 480 journaled on the respective upper and lower drive shafts 44, 46 to between for mounting the corresponding bearing arbors 210 thereon. In other embodiments, however, such bearings may not be employed. Also, a separate bearing mounting flange 290 may be journaled on a hub portion 211 of the bearing arbor and the drive flange 270. The bearing mounting flange 290 serves to clamp the inner bearing race of bearing assembly 230 and serves to house the O-ring grease seal therefor.

The knife holder assemblies 200′ are essentially identical in construction to the knife holder assemblies 200 except that the female stripper rings 400 are supported between the shearing face 244 of the knife 240 and the stripper retention flange 260 and the male stripper ring 500 is mounted between the mounting face 246 and the flange portion 233 of the knife shaft 232. The knife holder assemblies 200 and 200′ forming an upper and lower pair of assemblies are thus oriented such that the shearing edge 250 of the upper knife 240 and the shearing edge 250 of the lower knife 240 are essentially aligned with each other as shown in FIGS. 5 and 6, or they may be oriented with a slight vertical overlap—for example 0.025 inches open (negative)—0.025 inches overlap (positive). Accordingly, the knives 240 of each pair of knife holder assemblies 200, 200′ are positioned close enough to each other to enable them to cut or shear the metal sheet 12 (or other material) as it passes between those knives 240. The point at which the two knife edges 250 come together is referred to in the industry as the “nip”. The nip points have been generally designated as 251 in FIGS. 5, 6 and 11. In other words, the metal sheet 12 (or other material) is drawn between the two knives 240 of a pair of the knife holder assemblies 200, 200′ and the disk-like knives 240 shear the sheet 12 along the opposite cutting edges (the nip point 251), thus producing a clean longitudinal cut in the sheet.

FIGS. 7-10 illustrate one embodiment of a female compensating stripper ring 400 of the present invention that may be employed in connection with the knife holder assemblies 200, 200′ to accommodate or compensate for different material thicknesses. One female stripper ring 400 disclosed herein may be fabricated from a flexible material such as, for example, molded BUNA-N rubber material having a durometer of, for example, approximately 60-65. However, other materials with similar characteristics could be used. As can be seen in those Figures, a flexible female stripper ring 400 has a mounting hole 402 extending therethrough to enable the female stripper ring 400 to be journaled on the hub portion 233 of a knife shaft 232 (for knife holder assemblies 200) or on the stripper ring retention flange 260 (for knife holder assemblies 200′). In one embodiment for example, the female stripper ring 400 may have an outer diameter “OD” of approximately 13.240-13.245 inches (336.3-336.4 mm) and an inner diameter of approximately 11.499-11.501 inches (292.07-292.125 mm) and a central axis CA-CA. However, the female stripper ring 400 may be provided in other sizes that are tailored for a specific application.

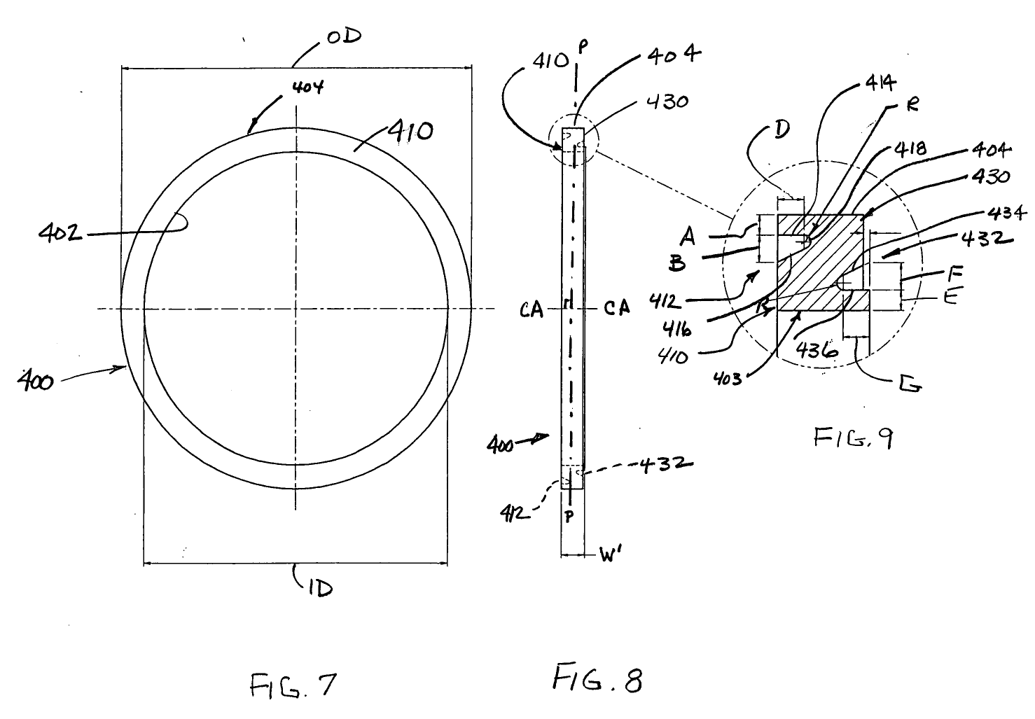

The female stripper ring 400 also has a circumferentially extending driving surface 404 and a first lateral face 410 that extends between the mounting hole 402 and the circumferentially extending driving surface 404. A second lateral face 430 extends opposite to the first lateral face 410 between the mounting hole 402 and the circumferentially extending driving surface 404. See FIG. 8. A first relief means or first annular groove 412 is formed in the first lateral face 410 and a second relief means or annular groove 432 is formed in the second lateral face 430.

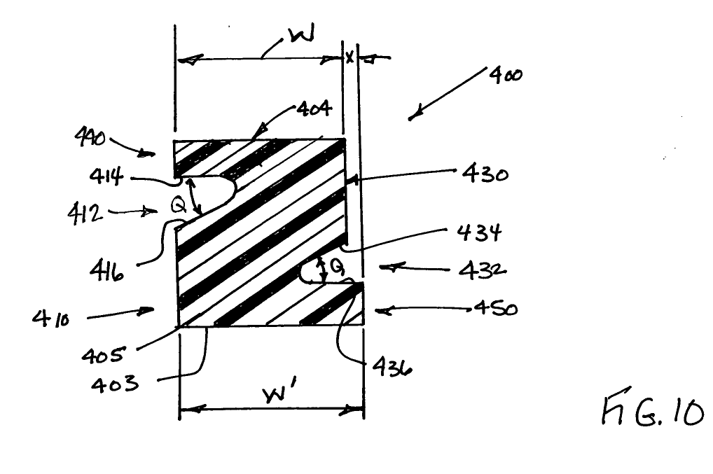

In various embodiments, the first annular groove 412 has a first outer wall 414 and a first inner wall 416. As can be seen in FIG. 9, the first outer wall 414 is closest to the circumferentially extending driving surface 404 and is spaced from the circumferentially extending driving surface 404 a first distance “A”. In one example, the first distance “A” maybe approximately 0.19 inches (4.9 mm) and the first outer wall 414 may be substantially concentric with the circumferentially extending driving surface 404. The first inner wall 416 may be spaced a first inner distance “B” of approximately 0.25 inches (6.35 mm) and may be arranged such that the first inner wall 416 is not substantially parallel to the first outer wall 414. In the example illustrated in FIG. 9, the first annular groove 412 may have a first depth “D” of approximately 0.25 inches (6.35 mm) and have a radiused bottom 418. In one example, the radius “R” may be approximately 0.06 inches (1.52 mm) and the angle “Q” between the first inner wall and first outer wall may be, for example, approximately 25°. See FIG. 10.

Similarly, the second annular groove 432 has a second outer wall 434 and a second inner wall 436. The second inner wall 436 is closer to the mounting hole 402 than the second outer wall 434 and is spaced from the mounting hole 402 a second distance “E” that may be substantially equal to the first distance “A” or it may differ from the first distance “A”. In the example depicted in FIG. 9, the distances “A” and “E” are substantially equal. The second outer wall 434 may be spaced from the second inner wall 436 a second inner distance “F” that may be substantially equal to the first inner distance “B” or it may differ from the first inner distance “B”. The second outer wall 434 may also be arranged such that it is not parallel to the second inner wall 436 and yet be substantially parallel to the first inner wall 416. Thus, in various embodiments, angle “Q” may be approximately 25°. In one embodiment, the second annular groove 432 may have a depth “G” that is substantially equal to the first depth “D” or it may differ from the first depth “D”. In the embodiment depicted in FIG. 9, depths “D” and “G” are substantially equal.

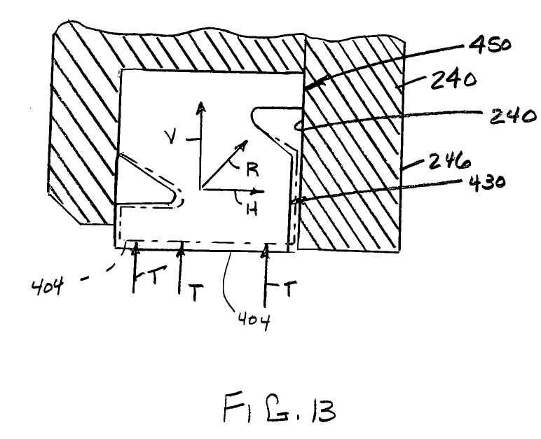

In female stripper ring embodiments disclosed herein, the first and second annular grooves are shaped to achieve “parallelogram-type” compression which serves to prevent or otherwise minimize point loading when the stripper rings are compressed. For example, the offset annular grooves 412, 432 with the tapered inward walls allow the female stripper ring to compress and move in a vertical direction (vector arrow “V” in FIG. 12) and also move in a horizontal direction (vector arrow “H” in FIG. 12).

As can be seen in FIG. 10, the circumferentially extending driving surface 404 has a first width “W”. The first annular groove 412 serves to define a first outer hub portion 440 in the first lateral face 410. Likewise, annular mounting surface 403 formed by mounting hole 402 in a central portion 405 has a second width “W” that is longer than first width “W” to form an inner hub portion 450 in the second lateral face 430. The inner hub portion 450 protrudes outwardly a distance “X” from the second lateral face 430. See FIG. 10. Such distance “X” serves to provide a gap which can accommodate the horizontal movement of the stripper ring 400 when under compression. Such unique and novel arrangement serves to facilitate the application of a constant vertical pinch (compression) load across the portion of the drive surface 404 under compression and thereby apply a slight tension to the strip material entering the slitter nip 251.

In various embodiments, the female stripper ring 400 in one knife holder assembly 200 is oriented adjacent one side of its corresponding knife 240 and the female stripper ring 400 in the complementary knife holder assembly 200′ is located on the opposite side of its corresponding knife 240. For example, as can be seen in FIG. 6, the female stripper ring 400 in the upper knife holder assembly 200 is oriented adjacent the left side (which is adjacent to the shearing face 244) of that knife 240. The female stripper ring 400 of the lower knife assembly 200′, however, is located on the right side (which is adjacent to the shearing face 244) of that knife 240. Thus, as can be seen in that Figure, the upper (left) female stripper ring 400 is free to move horizontally toward the right (arrow—“H”) when placed under compression during operation and the lower (right) stripper ring 400 is free to move horizontally (arrow “H”) toward the left when placed under compression during operation. Such flexing of the female stripper rings in opposing horizontal directions serves to apply a slight horizontal loading to the material and keep it relatively tight as it enters the nip 251.

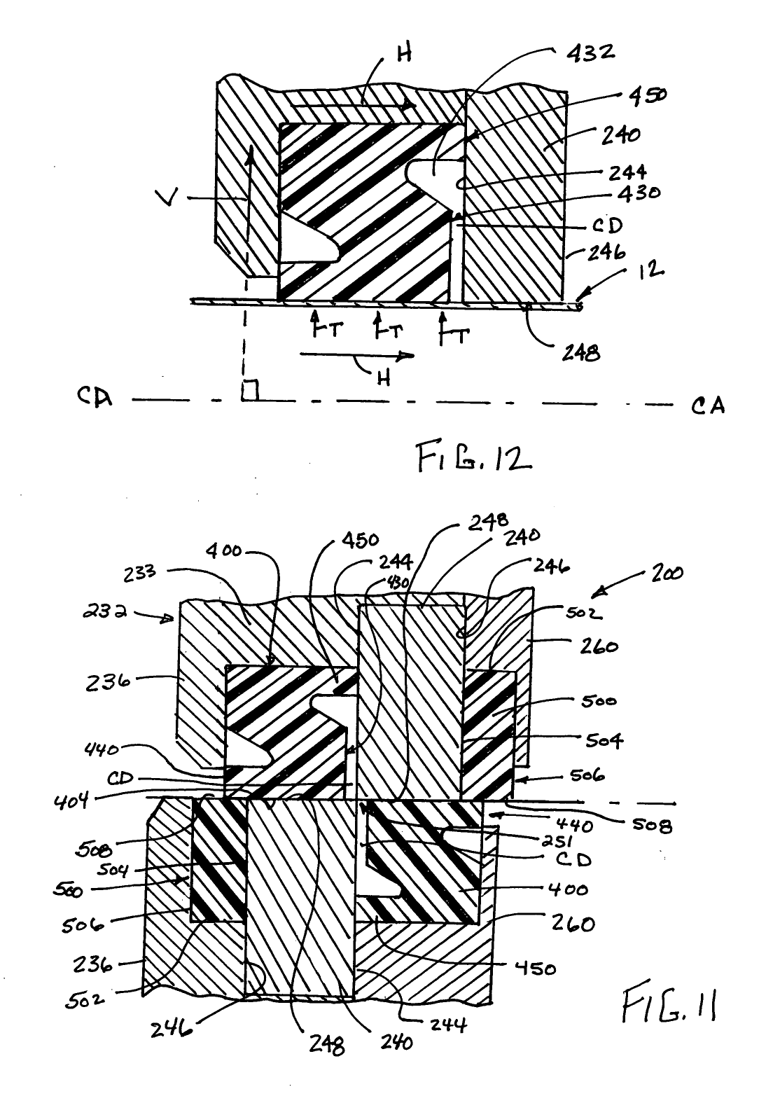

Also in various non-limiting embodiments, the knife holder assemblies 200, 200′ each further include a male stripper ring 500. See FIG. 11. The male stripper rings 500 have a mounting hole 502, a first lateral face 504 and a second lateral face 506 and a circumferentially extending driving surface 508. In various embodiments, the male stripper rings 500 may be fabricated from 70 to 75 durometer material. In various embodiments, the male stripper rings 500 are preferably stiffer (less compressive) than the female stripper rings 400 and are 0.010 inches to 0.020 inches large in diameter than the slitter knives 240 to prevent the non-cutting knife edge from marking the slit product.

FIG. 11 is an enlarged view illustrating the orientations of the male and female stripper rings 400, 500, respectively, in a knife holder assembly 200 relative to the female and male stripper rings 400, 500 in a knife holder assembly 200′ of a corresponding pair of knife holder assemblies 200, 200′. As can be seen in that Figure, the female stripper ring 400 of the knife holder 200 is mounted on the hub portion 233 of the knife shaft 232. The second lateral face 430 of the female stripper ring 400 is located adjacent to the shearing face 244 of the knife 240. The end of the inner hub portion 450 of the female stripper ring 400 abuts the shearing face 244 and serves to form a clearance distance “CD” between the shearing face 244 and the second lateral face 430 of the female stripper ring 400. The reader will appreciate that in an “unflexed” or “uncompressed” state, the clearance distance “CD” will be substantially equal to distance “X”. The circumferentially extending driving surface 404 of the female stripper ring 400 is in confronting relationship with the circumferentially extending surface 248 of the knife 240 in the corresponding knife holding assembly 200′ and also in confronting relationship with a portion of the circumferentially driving surface 508 of the male stripper ring 500 in the knife holding assembly 200′. The female and male stripper rings 400, 500 of one knife holder assembly 200 do not have to overlap the corresponding male and female stripper rings 400, 500 in a corresponding knife holder 200′. However, those rings will tend to overlap more as the knives are reconditioned (face ground) to a thickness of 0.50 inches from their original 0.75″ or whatever the case may be. As can be seen in FIG. 11, the female stripper ring 400 in the knife holding assembly 200′ is similarly oriented relative to the knife 240 and the male stripper ring 500 in the knife holding assembly 200.

As the material passes between the knife assemblies 200, 200′ on the upper and lower drive shafts 44, 46, the unique and novel female stripper rings 400 can essentially flex or compress in separate vertical and horizontal directions. The arrows “T” in FIGS. 12 and 13 represent the application of compression forces to the circumferentially driving surface 404 when the material 12 enters between the female stripper ring 400 and the opposing knife 240 and male stripper ring 500. As the female stripper ring 400 is compressed, it can deflect in a parallelogram-like fashion moving in a vertical direction (i.e., in a direction away from central axis CA-CA) which is represented by the vector arrows “V” in FIGS. 12 and 13 and also in a horizontal direction (in a direction essentially parallel to the central axis CA-CA) represented by the vector arrow “H”. As can be seen in FIG. 13, the female stripper ring 400 may move in a direction that is the resultant of the vertical and horizontal vectors (represented by the vector “R” in FIG. 13) such that the portion of the drive surface 404 that is under compression is substantially parallel with a corresponding portion of the mounting surface 403 thereby causing the female stripper ring to slightly “collapse” while retaining a parallelogram-like shape. FIG. 13 illustrates the parallelogram-like deflection in phantom lines. Such “multi-directional” defection of the female stripper rings 400 is accommodated by virtue of the first and second annular grooves 412, 432 and their diagonal orientation relative to each other. Thus, the reader will appreciate that such unique and novel compensating stripper ring arrangement enables the slitter to accommodate materials of varying thickness (within a range of acceptable thicknesses) without the need to exchange one diameter stripper rings with stripper rings having another diameter to enable the machine to accommodate different material thicknesses.

The invention which is intended to be protected is not to be construed as limited to the particular embodiments disclosed. The embodiments are therefore to be regarded as illustrative rather than restrictive. Variations and changes may be made by others without departing from the spirit of the present invention. Accordingly, it is expressly intended that all such equivalents, variations and changes which fall within the spirit and scope of the present invention as defined in the claims be embraced thereby.

What is claimed is:

1. A stripper ring for use on a material slitting machine, said stripper ring comprising:
a flexible ring having a mounting hole extending therethrough, said flexible ring further having a circumferentially extending driving surface and a first lateral face extending between said circumferentially extending driving surface and said mounting hole and a second lateral face extending from said circumferentially extending driving surface and said mounting hole;
a first annular groove in said first lateral face; and
a second annular a groove in said second lateral face.

2. The stripper ring of claim 1 wherein said first annular groove has a first outer wall and a first inner wall, the first outer wall spaced from said circumferentially extending driving surface a first distance and wherein said second annular groove has a second outer wall and a second inner wall, said second outer wall being spaced from said circumferentially extending driving surface a second distance that differs from said first distance.

3. The stripper ring of claim 2 wherein said first outer wall of said first annular groove is substantially concentric with said circumferentially extending driving surface.

4. The stripper ring of claim 3 wherein said first inner wall is not substantially parallel to said first outer wall of said first annular groove.

5. The stripper ring of claim 2 wherein said first inner wall is not substantially parallel to said first outer wall of said first annular groove.

6. The stripper ring of claim 2 wherein said mounting hole defines an annular mounting surface and wherein said second inner wall of said second annular groove is substantially concentric with said annular mounting surface.

7. The stripper ring of claim 6 wherein said second inner wall of said second annular groove is substantially concentric with said circumferentially extending driving surface.

8. The stripper ring of claim 6 wherein said second outer wall of said second annular groove is not substantially parallel to said second inner wall.

9. The stripper ring of claim 2 wherein said second inner wall of said second annular groove is not substantially parallel to said second outer wall.

10. The stripper ring of claim 2 wherein said first inner wall and said second outer wall are substantially parallel to each other.

11. The stripper ring of claim 1 wherein said mounting hole extends through a central portion of said stripper ring, said central portion defining a first width and wherein said circumferentially extending driving surface has a second width that is less than said first width.

12. The stripper ring of claim 2 wherein said circumferentially extending driving surface has a first width and wherein said mounting hole extends through a central portion of said stripper ring to define a mounting surface that has a second width that is greater than said first width.

13. A stripper ring for use on a material slitting machine, said stripper ring comprising a ring having a central portion with a mounting hole extending therethrough, said central portion further having a first lateral face with first relief means therein and a second lateral face with second relief means therein and a circumferentially extending driving surface, said first and second relief means enabling a portion of said stripper ring to deflect in at least two different directions upon the application of compressive force to said portion of said stripper ring.

14. The stripper ring of claim 13 wherein said first relief means comprises at least one first annular groove and wherein said second relief means comprises at least one second annular groove.

15. The stripper ring of claim 14 wherein at least one of said at least one first annular grooves has a first outer wall and a first inner wall, the first outer wall spaced from said circumferentially extending driving surface a first distance and wherein at least one of said at least one second annular grooves has a second outer wall and a second inner wall, said second outer wall being spaced from said circumferentially extending driving surface a second distance that differs from said first distance.

16. The stripper ring of claim 15 wherein said first outer wall of said first annular groove is substantially concentric with said circumferentially extending driving surface.

17. The stripper ring of claim 16 wherein said first inner wall is not substantially parallel to said first outer wall of said first annular groove.

18. The stripper ring of claim 15 wherein said first inner wall is not substantially parallel to said first outer wall of said first annular groove.

19. The stripper ring of claim 15 wherein said mounting hole defines an annular mounting surface and wherein said second inner wall of said second annular groove is substantially concentric with said annular mounting surface.

20. The stripper ring of claim 19 wherein said second inner wall of said annular groove is substantially concentric with said circumferentially extending driving surface.

21. The stripper ring of claim 19 wherein said second inner wall of said second annular groove is not substantially parallel to said second outer wall.

22. The stripper ring of claim 15 wherein said second inner wall of said second annular groove is not substantially parallel to said second outer wall.

23. The stripper ring of claim 15 wherein said first inner wall and said second outer wall are substantially parallel to each other.

24. The stripper ring of claim 13 wherein said mounting hole extends through a central portion of said stripper ring, said central portion defining a first width and wherein said circumferentially extending driving surface has a second width that is less than said first width.

25. A knife assembly for a slitting machine having a drive shaft, said knife assembly comprising:
a knife holder assembly attachable to said drive shaft for rotatable travel therewith;
a rotary knife supported by said knife holder assembly, said rotary knife having a shearing face, a circumferentially extending end surface and a mounting face, said shearing face and said circumferentially extending end surface forming a shearing edge;
a female stripper ring supported by said knife holder assembly adjacent said shearing face of said rotary knife, said female stripper ring having a first circumferentially extending driving surface formed thereon and being constructed to permit at least a portion of said female stripper ring to compress in two different directions upon the application of compressive force to a corresponding portion of said first circumferentially extending driving surface; and
a male stripper ring supported by said knife holder assembly adjacent said mounting face of said rotary knife.

26. The knife assembly of claim 25 wherein said female stripper ring has a first mounting hole extending therethrough for receipt of a corresponding first portion of said knife holder assembly therein and a first lateral face and a second lateral face opposite to said first lateral face and wherein said female stripper ring further comprises:
a first annular groove in said first lateral face; and
a second annular a groove in said second lateral face.

27. The knife assembly of claim 26 wherein said first annular groove has a first outer wall and a first inner wall, the first outer wall being closest to said first circumferentially extending driving surface than said first inner wall and is spaced from said circumferentially extending driving surface a first distance and wherein said second annular groove has a second outer wall and a second inner wall, said second outer wall being closer to said circumferentially extending driving surface than said second inner wall and being spaced from said first circumferentially extending driving surface a second distance that differs from said first distance.

28. The knife assembly of claim 27 wherein said first outer wall of said first annular groove is substantially concentric with said first circumferentially extending driving surface.

29. The knife assembly of claim 28 wherein said first inner wall is not substantially parallel to said first outer wall of said first annular groove.

30. The knife assembly of claim 27 wherein said first inner wall is not substantially parallel to said first outer wall of said first annular groove.

31. The knife assembly of claim 27 wherein said mounting hole defines an annular mounting surface and wherein said second inner wall of said second annular groove is substantially concentric with said annular mounting surface.

32. The knife assembly of claim 31 wherein said second inner wall of said annular groove is substantially concentric with said circumferentially extending driving surface.

33. The knife assembly of claim 21 wherein said second inner wall of said second annular groove is not substantially parallel to said second outer wall.

34. The knife assembly of claim 27 wherein said second inner wall of said second annular groove is not substantially parallel to said second outer wall.

35. The knife assembly of claim 29 wherein said first inner wall and said second outer wall are substantially parallel to each other.

36. The knife assembly of claim 25 wherein said mounting hole extends through a central portion of said female stripper ring, said central portion defining a first width and wherein said circumferentially extending driving surface has a second width that is less than said first width.

37. The knife assembly of claim 27 wherein said mounting hole extends through a central portion of said female stripper ring to define a mounting surface and wherein said second outer wall of said second annular groove is spaced from said annular mounting surface a third distance that is substantially equal to said first distance, said central portion defining a first width and wherein said circumferentially extending driving surface has a second width that is less than said first width.

38. The knife assembly of claim 26 wherein said first mounting hole has a first mounting hole axis and wherein said two different directions, comprise:
a first direction substantially parallel to said mounting hole axis; and
a second direction that is not substantially parallel to said mounting hole axis.

39. The knife assembly of claim 38 wherein said female stripper ring compresses in a direction that is a resulting sum of said first and second directions.

40. The knife assembly of claim 38 wherein said first direction is toward said shearing face.

41. A material slitting machine, comprising:
a driven upper shaft;
a driven lower shaft supported in spaced relation to said driven upper shaft;
at least one upper knife holder assembly mounted to said driven upper shaft, said at least one upper knife holder assembly comprising:
an upper rotary knife supported by said upper knife holder assembly, said upper rotary knife having an upper shearing face, an upper mounting face and a circumferentially extending upper end surface, said upper shearing face forming an upper shearing edge with said upper end surface;
an upper female stripper ring supported by said upper knife holder assembly adjacent said upper shearing face of said upper rotary knife, said upper female stripper ring having a circumferentially extending upper driving surface formed thereon and constructed to permit at least a portion of said upper female stripper ring to compress in two different directions upon an application of compressive force to a corresponding portion of said upper driving surface; and
an upper male stripper ring supported by said upper knife holder assembly adjacent said upper mounting face of said upper rotary knife;
at least one lower knife holder assembly mounted to said driven lower shaft, said at least one lower knife holder assembly corresponding to one of said at least one upper knife holder assemblies and comprising:
a lower rotary knife supported by said lower knife holder assembly, said lower rotary knife having a lower shearing face, a lower mounting face, and a circumferentially extending lower end, said lower shearing face forming a lower shearing edge with said lower end, said lower shearing edge being oriented adjacent to said upper shearing edge of said upper rotary knife corresponding thereto, said lower end of said lower rotary knife in confronting relationship with respect to at least a portion pf said first upper driving surface of said upper female stripper ring of said upper knife holder corresponding thereto;
a lower female stripper ring supported by said lower knife holder assembly adjacent said lower shearing face of said lower rotary knife, said lower female stripper ring having a circumferentially extending lower driving surface formed thereon and constructed to permit at least a portion of said lower female stripper ring to compress in two other different directions upon application of other compressive forces to a corresponding portion of said lower driving surface that is in confronting relationship with at least a portion of said upper male stripper ring and a portion of said upper rotary knife; and
a lower male stripper ring supported by said lower knife holder assembly adjacent said lower mounting face of said lower rotary knife and in confronting relationship relative to at least a portion of said upper drive surface of said upper female stripper ring.
